(19) United States
(12) Patent Application Publication
(10) Pub. No.: US 2025/0170786 A1
(43) Pub. Date: May 29, 2025

(54) CERAMIC COMPOSITE MANUFACTURING SYSTEMS AND METHODS

(71) Applicant: The Boeing Company, Arlington, VA (US)

(72) Inventors: Erik N. Wienhold, Seattle, WA (US); Sangvavann Heng, Buena Park, CA (US); Michael J. Trowbridge, Long Beach, CA (US); Brian J. Smith, Seattle, WA (US); Brice A. Johnson, Toledo, WA (US); Lisa C. Zgherea, Auburn, WA (US); Christopher R. Brown, Seattle, WA (US); Ricardo A. Fritzke, Sammamish, WA (US)

(73) Assignee: The Boeing Company, Arlington, VA (US)

(21) Appl. No.: 18/892,757

(22) Filed: Sep. 23, 2024

Related U.S. Application Data
(60) Provisional application No. 63/603,819, filed on Nov. 29, 2023.

(51) Int. Cl. B29C 70/38; B29C 70/54; C04B 35/83

(52) U.S. Cl. CPC B29C 70/382; B29C 70/541; C04B 35/83; C04B 2237/38

(57) ABSTRACT

A method includes steps of: (1) positioning an end effector relative to a ply of the ceramic composite material, wherein the end effector includes: a base; an arm that is coupled to and movable relative to the base; a base-gripper that is coupled to the base; and an arm-gripper that is coupled to the arm; (2) adhering the base-gripper to a first ply-portion of the ply; (3) adhering the arm-gripper to a second ply-portion of the ply; (4) moving the end effector relative to a forming-surface such that the first ply-portion of the ply is placed on a first surface-portion of the forming-surface; and (5) moving the arm relative to the base and to the forming-surface such that the second ply-portion is placed on a second surface-portion of the forming-surface, wherein the first surface-portion and the second surface-portion are non-coplanar.

### PRIORITY

This application claims priority from U.S. Ser. No. 63/603,819 filed on Nov. 29,2023, the entire contents of which are incorporated herein by reference.

### FIELD

The present disclosure relates generally to composite manufacturing and, more particularly, to manufacturing non-polymer composite structures, such as ceramic matrix composite structures, and, more particularly, to systems and methods for placing plies of a ceramic matrix composite material.

### BACKGROUND

Currently, placement of ceramic matrix composite plies on layup tools is performed manually or at least partially automatically using Pick-and-Place (PnP) tools. Placement of ceramic matrix composite plies over curved surfaces results in variable quality and inconsistencies in compaction. Additionally, such layup operations are time intensive, require inspection and rework and lead to overall increased life cycle time for placement and compaction of the ceramic matrix composite ply on the layup tool. Accordingly, those skilled in the art continue with research and development efforts in ceramic matrix composite manufacturing.

### SUMMARY

Disclosed are examples of a method for manufacturing a ceramic composite material, a method for positioning a ceramic composite material, and a system for manufacturing a ceramic composite material. The following is a non-exhaustive list of examples, which may or may not be claimed, of the subject matter according to the present disclosure.

In an example, the disclosed manufacturing method includes steps of: (1) picking up a ply of the ceramic composite material using an end effector; (2) moving the ply to a forming-surface using the end effector; and conforming the ply to a shape of the forming-surface using the end effector.

In an example, the disclosed positioning method includes steps of: (1) positioning an end effector relative to a ply of the ceramic composite material, wherein the end effector includes: a base; an arm that is coupled to and movable relative to the base; a base-gripper that is coupled to the base; and an arm-gripper that is coupled to the arm; (2) adhering the base-gripper to a first ply-portion of the ply; (3) adhering the arm-gripper to a second ply-portion of the ply; (4) moving the end effector relative to a forming-surface such that the first ply-portion of the ply is placed on a first surface-portion of the forming-surface; and (5) moving the arm relative to the base and to the forming-surface such that the second ply-portion is placed on a second surface-portion of the forming-surface, wherein the first surface-portion and the second surface-portion are non-coplanar.

In an example, the disclosed system includes a robotic manipulator and an end effector that is coupled to the robotic manipulator. The end effector includes a base and an arm that is coupled to and movable relative to the base. The end effector also includes a base-gripper that is coupled to the base. The end effector further includes an arm-gripper that is coupled to the arm. The base-gripper and the arm-gripper hold a ply of the ceramic composite material. The robotic manipulator moves the ply relative to a forming-surface such that a first ply-portion is placed on a first surface-portion of the forming-surface. The arm moves relative to the base and the forming-surface such that a second ply-portion of the ply is placed on a second surface-portion of the forming-surface.

Other examples of the system and the methods will become apparent from the following detailed description, the accompanying drawings, and the appended claims.

### BRIEF DESCRIPTION OF THE DRAWINGS

FIG. 1 is a flow diagram of an example of a method for manufacturing a ceramic matrix composite structure;

FIG. 2 is a flow diagram of an example of a method for positioning a ceramic matrix composite material;

FIG. 3 is a schematic block diagram of an example of a system for manufacturing a ceramic matrix composite structure;

FIG. 4 is a schematic illustration of an example of a portion of the system;

FIG. 5 is a schematic illustration of an example of a portion of the system;

FIG. 6 is a schematic illustration of an example of a portion of the system;

FIG. 7 is a schematic illustration of an example of a portion of the system;

FIG. 8 is a schematic illustration of an example of a portion of the system;

FIG. 9 is a schematic illustration of an example of a portion of the system;

FIG. 10 is a schematic illustration of an example of a portion of the system;

FIG. 11 is a schematic illustration of an example of a portion of the system;

FIG. 12 is a schematic illustration of an example of a portion of the system;

FIG. 13 is a schematic illustration of an example of a portion of the system;

FIG. 14 is a schematic illustration of an example of a portion of the system;

FIG. 15 is a schematic illustration of an example of a portion of the system;

FIG. 16 is a schematic illustration of an example of a portion of the system;

FIG. 17 is a schematic illustration of an example of a portion of the system;

FIG. 18 is a schematic illustration of an example of a portion of the system;

FIG. 19 is a flow diagram of an example of an aircraft manufacturing and service method; and

FIG. 20 is a schematic block diagram of an example of an aircraft.

### DETAILED DESCRIPTION

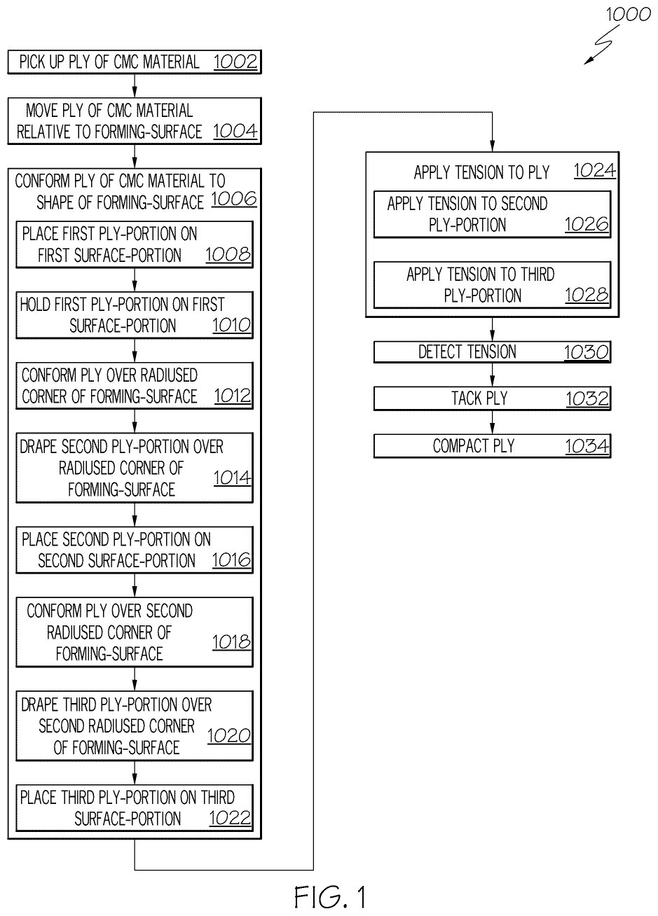

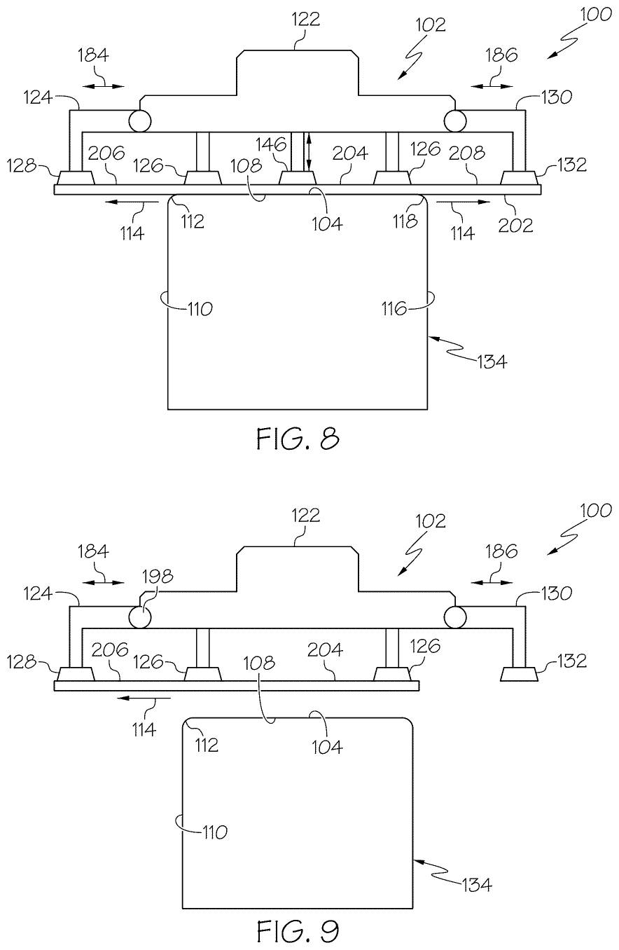

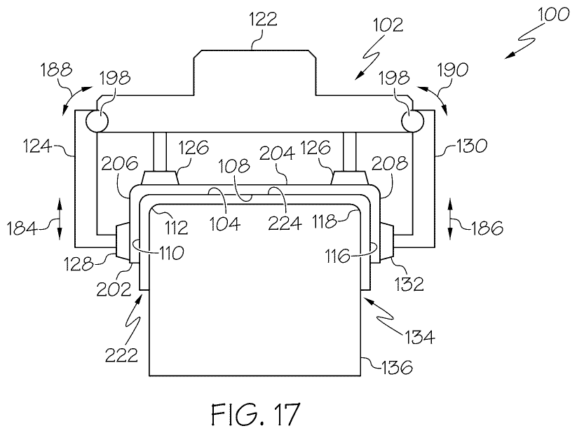

Referring generally to FIGS. 1-18, by way of examples, the present disclosure is directed to methods and systems for manufacturing a ceramic matrix composite (CMC) structure. More particularly, the present disclosure is directed to methods and systems for positioning a CMC material on a forming surface. The disclosed methods and the systems facilitate improvements in CMC manufacturing by providing controlled draping of a ply of CMC material during ply-by-ply formation of a CMC structure. While examples of the methods and system provide particular advantages and benefits related to manufacturing CMC structures, the methods and system can also be used in manufacturing other non-polymer composite structures.

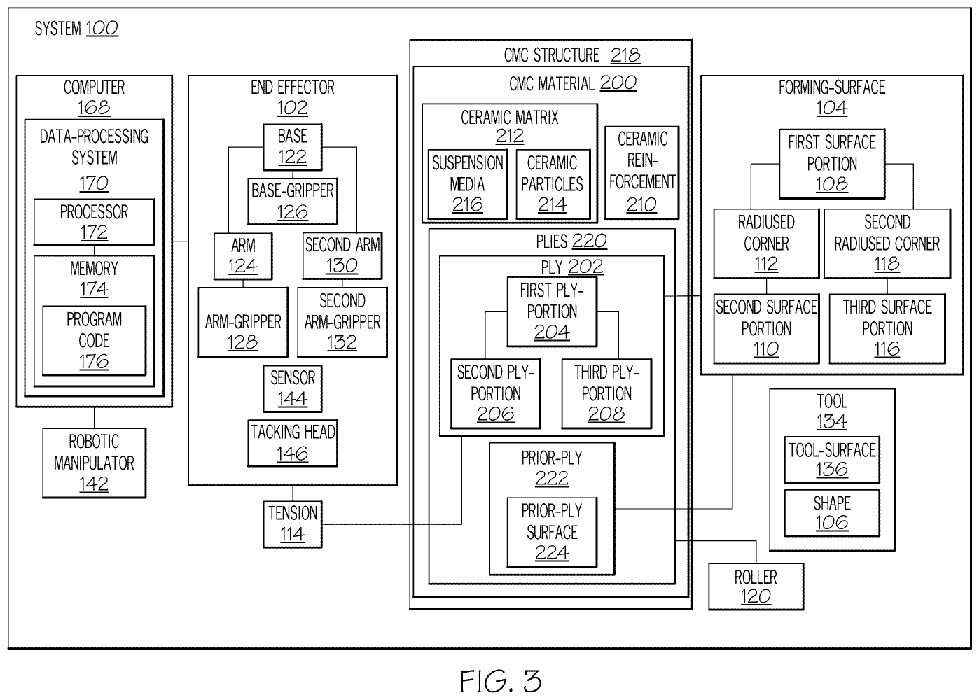

Referring to FIG. 3, ceramic matrix composites (CMCs) are a subgroup of composite materials and a subgroup of ceramics. Ceramic matrix composites include ceramic fibers embedded in a ceramic matrix. Both the fibers and the matrix can include any ceramic material, including carbon and carbon fibers. In one or more examples, a ceramic matrix composite material 200 is a ceramic matrix composite that includes a ceramic reinforcement 210 and a ceramic matrix 212.

In one or more examples, the ceramic reinforcement 210 is pre-impregnated with the ceramic matrix 212. In such examples, a ply 202 of the ceramic matrix composite material 200 can also be referred to as a ceramic matrix composite prepreg.

In one or more examples, the ceramic reinforcement 210 includes at least one of carbon reinforcement fibers, silicon carbide reinforcement fibers, alumina reinforcement fibers, alumina silica reinforcement fibers, aluminum nitride reinforcing fibers, silicon nitride reinforcement fibers, mullite reinforcement fibers, silica/quartz reinforcement fibers, basalt reinforcement fibers, and zirconia reinforcement fibers. Other suitable reinforcement materials are also contemplated for use as the ceramic reinforcement 210.

In one or more examples, the ceramic matrix 212 includes at least one of a carbon matrix, a silicon carbide matrix, an alumina matrix, an alumina silica matrix, an aluminum nitride matrix, a silicon nitride matrix, a mullite matrix, a geo-polymer matrix, and a zirconia matrix. Other suitable matrix materials are also contemplated for use as the ceramic matrix 212.

In one or more examples, the ceramic matrix 212 includes ceramic particles 214 dispersed in a suspension media 216 (e.g., fluid or other vehicle). In one or more examples, the ceramic matrix 212 is an aqueous suspension (e.g., the suspension media 216 is an aqueous media). In one or more examples, the ceramic matrix 212 is a non-aqueous suspension (e.g., the suspension media 216 is a non-aqueous media). The ceramic matrix 212 has various viscosities depending on the suspension media 216 used. In one or more examples, the ceramic particles 214 include at least one of carbon particles, silicon carbide particles, alumina particles, alumina silica particles, aluminum nitride particles, silicon nitride particles, mullite particles, geo-polymer particles, and zirconia particles. Other suitable materials are also contemplated for use as the ceramic particles 214.

Typically, ceramic matrix composites have different tack and texture than polymer matrix composites (PMCs). As an example, the reinforcement material (e.g., ceramic reinforcement 210) of a fabric-based ceramic matrix composite, such as ceramic fibers, is more brittle and/or is stiffer than the reinforcement material of a fabric-based polymer matrix composite (PMC), such as carbon fibers. Additionally, the matrix material (e.g., ceramic matrix 212) of a fabric-based ceramic matrix composite is less viscous or has different tack characteristics than the matrix material of a fabric-based polymer matrix composite. More brittle and stiffer fibers along with different tack resin require different systems and methods for Pick-and-Place (PnP) processing. As such, traditional Pick-and-Place techniques and tools used with polymer matrix composites are not suitable for use with ceramic matrix composites.

Additionally, Pick-and-Place robotic layup of fabric-based ceramic matrix composites (e.g., ceramic matrix composite prepregs) often require positioning and compaction of plies of ceramic matrix composite prepreg over a formation and compaction surface having a relatively tight radius or high curvature to form a part geometry with a corresponding tight radius or high curvature. To accomplish this, the system 100, the method 1000, and the method 2000 utilize a unique end effector with articulating grippers to control ply draping and, thereby, to prevent formation of defects during placement and compaction.

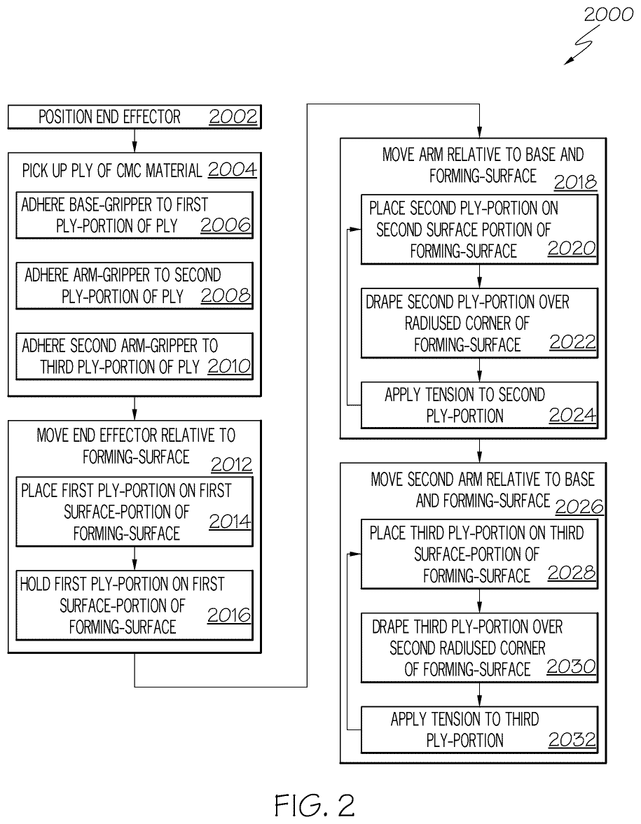

FIG. 1 is a flow diagram illustrating an example of a method 1000 for manufacturing a ceramic matrix composite material 200. FIG. 2 is a flow diagram illustrating an example of a method 2000 for positioning the ceramic matrix composite material 200. In one or more examples, the method 2000 forms a portion of or is an example of the method 1000 (FIG. 1). FIG. 3 is a schematic block diagram of an example of a system 100 for manufacturing the ceramic matrix composite material 200. Examples of the system 100 are used to implement the method 1000 and/or the method 2000. Generally, the method 1000, the method 2000, and the system 100 are applicable to automated pick-and-place of fabric-based ceramic matrix prepreg, which results in improved part quality and reduced rework.

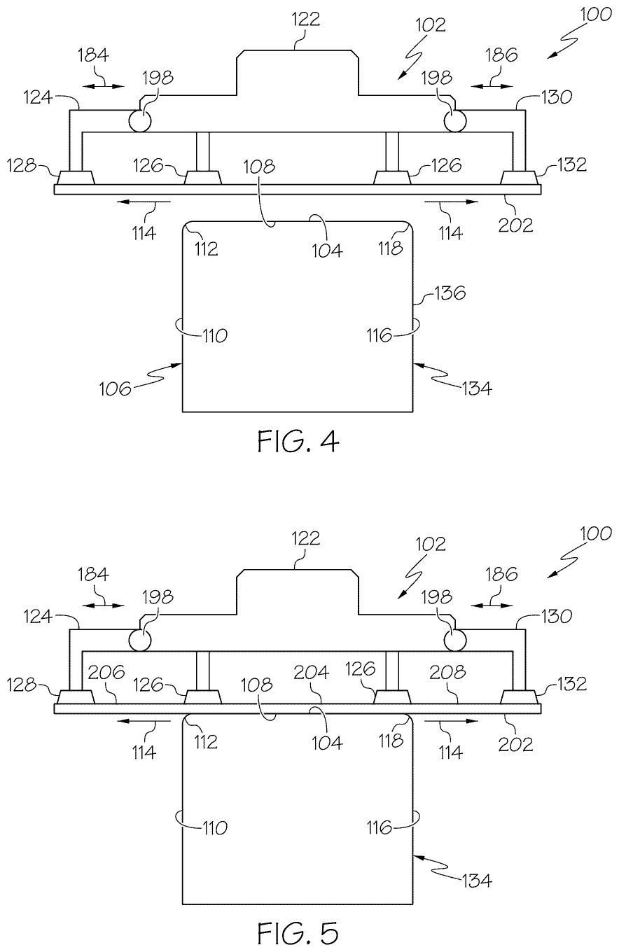

FIGS. 4-18 illustrate various examples of the system 100. FIGS. 4-18 illustrate the system 100 being used to position a ply 202 of the ceramic matrix composite material 200 on a forming-surface 104. Generally, a plurality of plies 220 (FIG. 3) is placed (e.g., stacked, one on top of the next) on a tool 134 to form a ceramic matrix composite structure 218 (FIG. 3). As such, in one or more examples, the ceramic matrix composite structure 218 includes or is formed by the stacked plurality of plies 220.

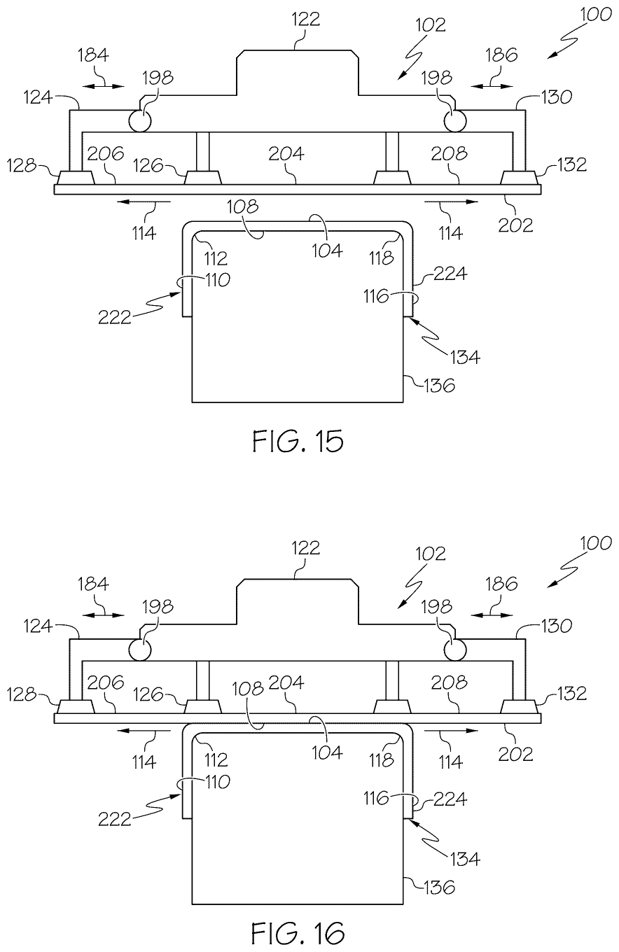

The tool 134 includes or takes the form of any suitable layup tool or mandrel, forming tool or mandrel, compaction tool or mandrel, cure tool or mandrel, and the like. In the examples illustrated in FIGS. 4-14, the forming-surface 104 is formed by a tool-surface 136 of the tool 134. In the examples illustrated in FIGS. 15-17, the forming-surface 104 is formed by a prior-ply-surface 224 of a prior-ply 222. The prior-ply 222 is a ply of the ceramic matrix composite material 200 that has been previously positioned on the tool 134 or on a previously placed ply and upon which a currently placed ply is positioned, for example, using the system 100.

The tool 134 can have various configurations and/or geometries, for example, depending on the geometry of the ceramic matrix composite structure 218 being manufactured using the system 100 and/or according to the method 1000 and/or the method 2000. The tool 134 can have any suitable cross-sectional shape (e.g., square, rectangular, circular, elliptical, etc.) and have any suitable cross-sectional geometry. The tool 134 can have a constant cross-sectional shape and/or geometry along its length. Alternatively, the tool 134 can have a variable cross-sectional shape and/or geometry along its length. The tool 134 can have any number of surface portions that define the shape of the ceramic matrix composite structure 218 formed on the tool 134. The surface portions can be planar or contoured. The surface portions can be oriented at various angular orientations relative to each other. The surface portions can have various contours or surface curvatures. The tool 134 can include one or more radiused corners or edges located between different surface portions. The system 100, the method 1000, and the method 2000 facilitate controlled draping of the ply 202 over such radiused corners, edges, or other contoured surface portions during placement of the ply 202.

As illustrated in FIGS. 4-18, examples of the system 100 and the methods 1000, 2000 facilitate automated placement of the ply 202 on the forming-surface 104 using an end effector 102. As illustrated in FIGS. 4, 9, 12, 15 and 18, the system 100 automatically picks up the ply 202, for example, in a generally flat or planar configuration using the end effector 102. As illustrated in FIGS. 5, 10, 13 and 16, the system 100 moves the ply 202 to the forming-surface 104 and places at least a portion of the ply 202 on the forming-surface 104 using the end effector 102. As illustrated in FIGS. 3, 11, 14 and 17, the system 100 holds the ply 202 in position on the forming-surface 104 while controllably draping another portion of the ply 202 over the radiused edges or contoured surfaces of the forming-surface 104. As such, examples of the system 100 and the methods 1000, 2000 are applicable to ply-by-ply placing and forming techniques. In one or more examples, steps of placing the ply 202 include a step of selectively orienting the fibers of the ply 202.

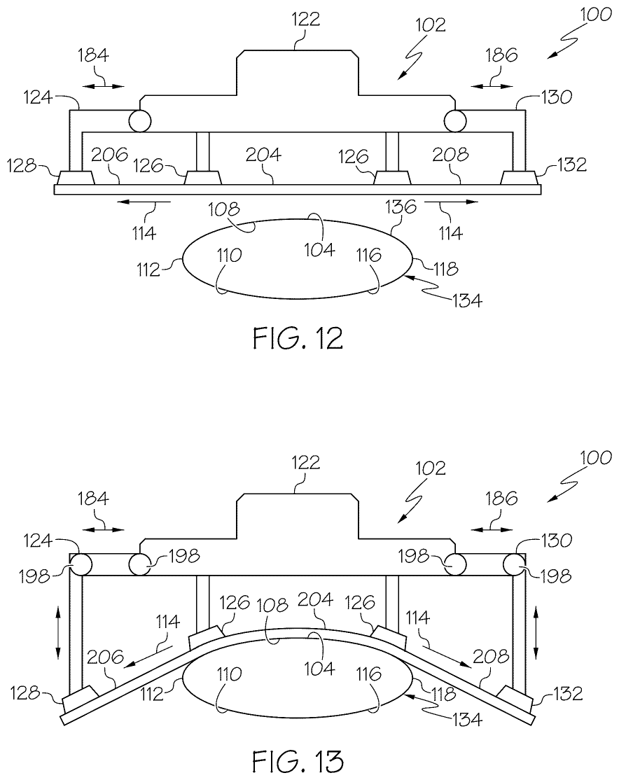

As illustrated in FIGS. 4-6 and 15-17, in one or more examples, the system 100 and the methods 1000, 2000 are used to form the ceramic matrix composite structure 218 having a “C”-shape in cross section (e.g., a C-channel). As illustrated in FIGS. 8-11, in one or more examples, the system 100 and the methods 1000, 2000 are used to form the ceramic matrix composite structure 218 having a “L”-shape in cross section (e.g., an L-channel). As illustrated in FIGS. 12-14, in other examples, the system 100 and the methods 1000, 2000 can be used to form the ceramic matrix composite structure 218 having other open cross-sectional shapes. In one or more examples, the system 100 and the methods 1000, 2000 are used to form the ceramic matrix composite structure 218 having a closed cross-sectional shape, such as circular, elliptical, square, rectangular, and the like.

Referring particularly to FIG. 1 and generally to FIGS. 3-18, the following are examples of the method 1000, according to the present disclosure. In one or more examples, the method 1000 is implemented using the system 100 or the end effector 102 (e.g., FIGS. 3-18). The method 1000 includes a number of elements, steps, and/or operations. Not all of the elements, steps, and/or operations described or illustrated in one example are required in that example. Some or all of the elements, steps, and/or operations described or illustrated in one example can be combined with other examples in various ways without the need to include other elements, steps, and/or operations described in those other examples, even though such combination or combinations are not explicitly described or illustrated by example herein.

In one or more examples, one or more steps of the method 1000 are electronically controlled or computer controlled (e.g., under direction of a computer 168). As such, in one or more examples, the method 1000 is an electronically-controller method or a computer-implemented method.

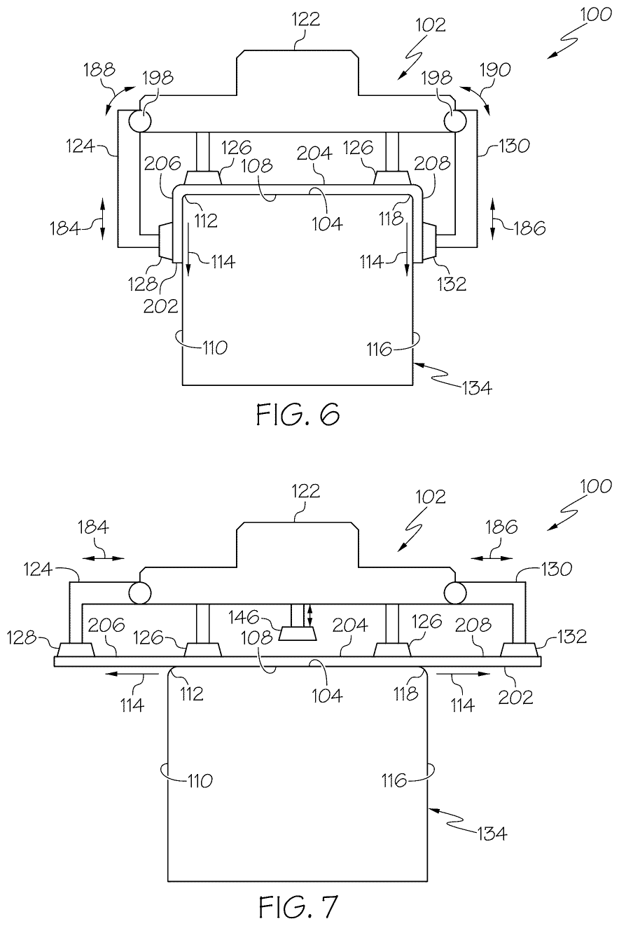

Referring particularly to FIG. 1 and generally to FIGS. 3-18, in one or more examples, the method 1000 includes a step of (block 1002) picking up the ply 202 of the ceramic matrix composite material 200. In one or more examples, the ply 202 is picked up using the end effector 102 (e.g., FIGS. 4, 9, 12 and 15). The method 1000 includes a step of (block 1004) moving the ply 202 to the forming-surface 104. In one or more examples, the ply 202 is moved using the end effector 102 (e.g., FIGS. 5, 10, 12 and 16). The method 1000 includes a step of (block 1006) conforming the ply 202 to a shape 106 of the forming-surface 104. In one or more examples, the ply 202 is conformed to the shape 106 of the forming-surface 104 using the end effector 102 (e.g., FIGS. 6, 11, 14 and 17).

Referring particularly to FIG. 1 and generally to FIGS. 3, 6, 11, 14 and 17, in one or more examples, the conforming step (block 1006) includes a step of (block 1012) forming the ply 202 over a radiused corner 112 of the forming-surface 104.

Referring particularly to FIG. 1 and generally to FIGS. 3, 6, 14 and 17, in one or more examples, the conforming step (block 1006) includes a step of (block 1018) forming the ply 202 over a second radiused corner 118 of the forming-surface 104.

The forming-surface 104 can have any one of various shapes (e.g., shape 106). Generally, the shape 106 of the forming-surface 104 is defined by the cross-sectional shape of the tool 134. As examples, the tool 134 and, thus, the forming-surface 104, can have a square shape in cross section, a circular shape in cross section, an elliptical shape in cross section, or other shape. The forming-surface 104 can be formed by a portion of or an entirety of the tool 134.

Referring particularly to FIG. 1 and generally to FIGS. 3-17, in one or more examples, the conforming step (block 1006) includes a step of (block 1008) placing a first ply-portion 204 of the ply 202 on a first surface-portion 108 of the forming-surface 104. In one or more examples, the first ply-portion 204 is placed on the first surface-portion 108 using the end effector 102 (e.g., FIGS. 5, 10, 13 and 16). The conforming step (block 1006) includes a step of (block 1016) placing a second ply-portion 206 of the ply 202 on a second surface-portion 110 of the forming-surface 104. In one or more examples, the second ply-portion 206 is placed on the second surface-portion 110 using the end effector 102 (e.g., FIGS. 6, 11, 14 and 17). In one or more examples, the first surface-portion 108 and the second surface-portion 110 are non-coplanar (e.g., FIGS. 4-18).

Referring to FIGS. 4-11 and 15-17, in one or more examples, according to the method 1000, the first surface-portion 108 and the second surface-portion 110 of the forming-surface 104 are at least approximately perpendicular to each other. In these examples, the first ply-portion 204 and the second ply-portion 206 are positioned at least approximately perpendicular to each other on the forming-surface 104 such that a first portion and a second portion of the ceramic matrix composite structure 218 are at least approximately perpendicular to each other (e.g., a C-channel, an L-channel, and the like).

Referring to FIGS. 12-14, in one or more examples, according to the method 1000, the first surface-portion 108 and the second surface-portion 110 of the forming-surface 104 are at non-perpendicular and non-parallel to each other. In these examples, the first ply-portion 204 and the second ply-portion 206 are positioned non-perpendicular and non-parallel (e.g., oblique) to each other on the forming-surface 104 such that a first portion and a second portion of the ceramic matrix composite structure 218 are non-perpendicular and non-parallel to each other.

Referring particularly to FIG. 1 and generally to FIGS. 3-17, in one or more examples, the conforming step (block 1006) includes a step of (block 1010) holding the first ply-portion 204 of the ply 204 on the first surface-portion 108 of the forming-surface 104. In one or more examples, the first ply-portion 204 is held in place on the first surface-portion 108 using the end effector 102 (e.g., FIGS. 5, 7, 10 and 13). The conforming step (block 1006) also includes a step of (block 1016) draping the second ply-portion 206 of the ply 204 over the radiused corner 112, or radiused edge, of the forming-surface 104 between the first surface-portion 108 and the second surface-portion 110 of the forming-surface 104. In one or more examples, the second ply-portion 206 is draped over the radiused corner 112 using the end effector 102 (e.g., FIGS. 6, 11, 14 and 17). In one or more examples, the step of (block 1014) draping the second ply-portion 206 over the radiused corner 112 is performed before or during the step of (block 1016) placing the second ply-portion 206 of the ply 202 on the second surface-portion 110.

Referring particularly to FIG. 1 and generally to FIGS. 3-17, in one or more examples, the conforming step (block 1006) includes a step of (block 1026) applying tension 114 to the second ply-portion 206 of the ply 202. In one or more examples, the tension 114 is applied using the end effector 102. In one or more examples, the step of (block 1024) applying the tension 114 is performed during the step of (block 1014) draping the second ply-portion 206 over the radiused corner 112 of the forming-surface 104 and the step of (block 1016) placing the second ply-portion 206 on the second surface-portion 110 of the forming-surface 104.

Generally, tension 114 is applied (block 1026) to the ply 202, such as the second ply-portion 206, to enable the controlled draping (block 1014) and placing (block 1016) of the second ply-portion 206 during the ply-forming process. In some examples, tension 114 is applied to the extent necessary to maintain tautness in the ply 202 and/or to minimize slack or drooping of the ply 202 during the ply-forming process. In some examples, tension 114 is not required and, therefore, is not applied.

Referring particularly to FIG. 1 and generally to FIGS. 3-6 and 12-17, in one or more examples, the conforming step (block 1006) includes a step of (block 1022) placing a third ply-portion 208 of the ply 202 on a third surface-portion 116 of the forming-surface 104. In one or more examples, the third ply-portion 208 is placed on the third surface-portion 116 using the end effector 102 (e.g., FIGS. 6, 14 and 17). In one or more examples, the first surface-portion 108 and the third surface-portion 116 are non-coplanar.

Referring to FIGS. 4-6 and 12-17, in one or more examples, according to the method 1000, the first surface-portion 108 and the third surface-portion 116 of the forming-surface 104 are at least approximately perpendicular to each other. In these examples, the first ply-portion 204 and the third ply-portion 208 are positioned at least approximately perpendicular to each other on the forming-surface 104 such that a first portion and a second portion of the ceramic matrix composite structure 218 are at least approximately perpendicular to each other (e.g., a C-channel, an L-channel, and the like).

Referring to FIGS. 4-6 and 12-17, in one or more examples, according to the method 1000, the second surface-portion 110 and the third surface-portion 116 of the forming-surface 104 are at least approximately parallel to each other. In these examples, the second ply-portion 206 and the third ply-portion 208 are positioned at least approximately parallel to each other on the forming-surface 104 such that a second portion and a third portion of the ceramic matrix composite structure 218 are at least approximately parallel to each other (e.g., a C-channel).

Referring particularly to FIG. 1 and generally to FIGS. 3-6 and 12-17, in one or more examples, the conforming step (block 1006) includes a step of (block 1020) draping the third ply-portion 208 of the ply 204 over the second radiused corner 118, or radiused edge, of the forming-surface 104 between the first surface-portion 108 and the third surface-portion 116 of the forming-surface 104. In one or more examples, the third ply-portion 208 is draped over the second radiused corner 118 using the end effector 102 (e.g., FIGS. 6, 14 and 17). In one or more examples, the step of (block 1020) draping the third ply-portion 208 over the second radiused corner 118 is performed before or during the step of (block 1022) placing the third ply-portion 208 of the ply 202 on the third surface-portion 116.

Referring particularly to FIG. 1 and generally to FIGS. 3-17, in one or more examples, the conforming step (block 1006) includes a step of (block 1028) applying tension 114 to the third ply-portion 208 of the ply 202. In one or more examples, tension 114 is applied to the third ply-portion 208 using the end effector 102. In one or more examples, the step of (block 1028) applying the tension 114 is performed during the step of (block 1020) draping the third ply-portion 208 over the second radiused corner 118 of the forming-surface 104 and the step of (block 1022) placing the third ply-portion 208 on the third surface-portion 116 of the forming-surface 104.

Generally, tension 114 is applied (block 1028) to the ply 202, such as the third ply-portion 208, to enable the controlled draping (block 1020) and placing (block 1022) of the third ply-portion 208 during the ply-forming process. In some examples, tension 114 is applied to the extent necessary to maintain tautness in the ply 202 and/or to minimize slack or drooping of the ply 202 during the ply-forming process. In some examples, tension 114 is not required and, therefore, is not applied.

Referring particularly to FIG. 1 and generally to FIGS. 3-17, in one or more examples, the method 1000 includes a step of (block 1024) applying tension 114 to the ply 202. In one or more examples, tension 114 is applied to the ply 202 using the end effector 102. In one or more examples, the step of (block 1024) applying tension 114 is performed during the step of (block 1006) conforming the ply 202 to the forming-surface 104. In one or more examples, the step of (block 1026) applying tension 114 to the second ply-portion 206 and the step of (block 1028) applying tension 114 to the third ply-portion 208 are examples of the step of (block 1024) applying tension 114.

Referring particularly to FIG. 1, in one or more examples, the method 1000 includes a step of (block 1030) detecting tension 114 applied to the ply 202. In one or more examples, tension 114 applied to the ply 202 is detected using the end effector 102.

Referring particularly to FIG. 1 and generally to FIGS. 3, in one or more examples, the method 1000 includes a step of (block 1034) compacting the ply 202 on the forming-surface 104 and across the radiused corner 112. In one or more examples, the ply 202 is compacted on the forming-surface 104 using a roller 120 (FIG. 3). The roller 120 can be a manual roller or an at least partially automated roller, such as integrated with the end effector 102 or with a separate, dedicated compacting end effector.

Referring particularly to FIG. 1 and generally to FIGS. 3, 7 and 8, in one or more examples, the method 1000 includes a step of (block 1032) tacking the ply 202 to the forming-surface 104. In one or more examples, the step of (block 1032) tacking the ply 202 is performed before the step of (block 1034) compacting the ply 202. In one or more examples, the tacking step (block 1032) is performed using a tacking head 146, which is selectively actuated to press the ply 202 against the forming-surface 104 at one or more tacking locations.

Referring particularly to FIG. 1 and generally to FIGS. 3-18, in one or more examples, the end effector 102 includes a base 122, an arm 124, a base-gripper 126, and an arm-gripper 128. The arm 124 is coupled to the base 122. The arm 124 is movable relative to the base 122. The base-gripper 126 is coupled to the base 122. The arm-gripper 128 is coupled to the arm 124. The step of (block 1002) picking up the ply 202 includes a step of adhering the base-gripper 126 to the first ply-portion 204 of the ply 202 and a step of adhering the arm-gripper 128 to the second ply-portion 206 of the ply 202. The step of (block 1006) conforming the ply 202 includes a step of moving the end effector 102 relative to the forming-surface 104 such that the first ply-portion 204 of the ply 202 is placed on the first surface-portion 108 of the forming-surface 104 and a step of moving the arm 124 relative to the base 122 and to the forming-surface 104 such that the second ply-portion 206 is placed on the second surface-portion 110 of the forming-surface 104. In one or more examples, the first surface-portion 108 and the second surface-portion 110 are non-coplanar.

Referring particularly to FIG. 1 and generally to FIGS. 3-17, in one or more examples, the conforming step (block 1006) includes a step of holding the first ply-portion 204 on the first surface-portion 108 using the base 122 and the base-gripper 126. In one or more examples, the conforming step (block 1006) also includes a step of moving the arm 124 relative to the base 122 and to the forming-surface 104 such that the second ply-portion 206 is draped over the radiused corner 112 of the forming-surface 104 between the first surface-portion 108 and the second surface-portion 110 of the forming-surface 104.

Referring particularly to FIG. 1 and generally to FIGS. 3-17, in one or more examples, the conforming step (block 1006) includes a step of moving the arm 124 relative to the base 122 such that tension 114 is applied to the second ply-portion 206 of the ply 202.

Referring particularly to FIG. 1, in one or more examples, the step of adhering the base-gripper 126 and the arm-gripper 128 to the ply 202 includes a step of applying a vacuum to the ply 202.

Referring particularly to FIG. 1 and generally to FIGS. 3-18, in one or more examples, the end effector 102 also includes a second arm 130 and a second arm-gripper 132. The second arm 130 is coupled to the base 122. The second arm 130 is movable relative to the base 122. The second arm-gripper 132 is coupled to the second arm 130. The step of (block 1002) picking up the ply 202 also includes a step of adhering the second arm-gripper 132 to the third ply-portion 208 of the ply 202. The step of (block 1006) conforming the ply 202 also includes a step of moving the second arm 130 relative to the base 122 and to the forming-surface 104 such that the third ply-portion 208 is placed on the third surface-portion 116 of the forming-surface 104. In one or more examples, the first surface-portion 108 and the third surface-portion 116 are non-coplanar.

In examples of the end effector 102 having the second arm 130, the arm 124 may be referred to as a first arm. In examples of the end effector 102 having the second arm 130, the arm-gripper 128 may be referred to as a first arm-gripper.

Referring particularly to FIG. 1 and generally to FIGS. 3-8 and 12-17, in one or more examples, the conforming step (block 1006) includes a step of holding the first ply-portion 204 on the first surface-portion 108 using the base 122 and the base-gripper 126. In one or more examples, the conforming step (block 1006) also includes a step of moving the second arm 130 relative to the base 122 and to the forming-surface 104 such that the third ply-portion 208 is draped over the second radiused corner 118 of the forming-surface 104 between the first surface-portion 108 and the third surface-portion 116 of the forming-surface 104.

Referring particularly to FIG. 1 and generally to FIGS. 3-8 and 12-17, in one or more examples, the conforming step (block 1006) includes a step of moving the second arm 130 relative to the base 122 such that tension 114 is applied to the third ply-portion 208 of the ply 202.

Referring particularly to FIG. 1 and generally to FIGS. 3-14, in one or more examples, the forming-surface 104 includes or is formed by at least a portion of the tool-surface 136 of the tool 134.

Referring particularly to FIG. 1 and generally to FIGS. 15-17, in one or more examples, the forming-surface 104 includes or is formed by at least a portion of the prior-ply-surface 224 of the prior-ply 222 of the ceramic matrix composite material 200.

Referring particularly to FIG. 2 and generally to FIGS. 3-18, the following are examples of a method 2000 for positioning the ceramic matrix composite material 200, for example, during manufacture of the ceramic matrix composite structure 218, according to the present disclosure. In one or more examples, the method 2000 is implemented using the system 100 or the end effector 102 (e.g., FIGS. 3-18). In one or more examples, the method 2000 forms a portion of or is included by the method 1000 (e.g., FIG. 1). The method 2000 includes a number of elements, steps, and/or operations. Not all of the elements, steps, and/or operations described or illustrated in one example are required in that example. Some or all of the elements, steps, and/or operations described or illustrated in one example can be combined with other examples in various ways without the need to include other elements, steps, and/or operations described in those other examples, even though such combination or combinations are not explicitly described or illustrated by example herein.

In one or more examples, one or more steps of the method 2000 are electronically controlled or computer controlled (e.g., under direction of the computer 168). As such, in one or more examples, the method 2000 is an electronically-controller method or a computer-implemented method.

Referring particularly to FIG. 1 and generally to FIGS. 3-18, in one or more examples, the method 2000 includes a step of (block 2002) positioning the end effector 102 relative to the ply 202 of the ceramic matrix composite material 200. The end effector 102 includes the base 122. The end effector 102 includes the arm 124 that is coupled to and movable relative to the base 122. The end effector 102 includes the base-gripper 126 that is coupled to the base 122. The end effector 102 includes the arm-gripper 128 that is coupled to the arm 124. The method 2000 includes a step of (block 2004) picking up the ply 202 of the ceramic matrix composite material 200 using the end effector 102. The method 2000, such as the step of (block 2004) picking up the ply 202, includes a step of (block 2006) adhering the base-gripper 126 to the first ply-portion 204 of the ply 202 and a step of (block 2008) adhering the arm-gripper 128 to the second ply-portion 206 of the ply 202. The method 2000 includes a step of (block 2012) moving the end effector 102 relative to a forming-surface 104 such that the first ply-portion 204 of the ply 202 is placed on a first surface-portion 108 of the forming-surface 104 (block 2014). The method 2000 includes a step of (block 2018) moving the arm 124 relative to the base 122 and to the forming-surface 104 such that the second ply-portion 206 is placed on the second surface-portion 110 of the forming-surface 104 (block 2020). In one or more examples, the first surface-portion 108 and the second surface-portion 110 are non-coplanar.

Referring particularly to FIG. 1 and generally to FIGS. 3-17, in one or more examples, the method 2000 includes a step of (block 2016) holding the first ply-portion 204 on the first surface-portion 108. As an example, the end effector 102 is moved relative to the forming-surface 104 (block 2012) such that the first ply-portion 204 of the ply 202 is held on the first surface-portion 108 of the forming-surface 104 (block 2016) using the base 122 and the base-gripper 126. The method 2000 includes a step of (block 2022) draping the second ply-portion 206 over the radiused corner 112 of the forming-surface 104 between the first surface-portion 108 and the second surface-portion 110 of the forming-surface 104. As an example, the arm 124 is moved relative to the base 122 and to the forming-surface 104 (block 2018) such that the second ply-portion 206 is draped over the radiused corner 112 of the forming-surface 104 between the first surface-portion 108 and the second surface-portion 110 of the forming-surface 104 (block 2022).

Referring particularly to FIG. 1 and generally to FIGS. 3-17, in one or more examples, the method 2000 includes a step of (block 2024) applying tension 114 to the second ply-portion 206. As an example, the arm 124 is moved relative to the base 122 (block 2018) such that tension 114 is applied to the second ply-portion 206 of the ply 202 (block 2024).

Referring particularly to FIG. 1 and generally to FIGS. 3-8 and 12-17, in one or more examples, the method 2000, such as the step of (block 2004) picking up the ply 202, includes a step of (block 2010) adhering the second arm-gripper 132 to the third ply-portion 208 of the ply 202.

Referring particularly to FIG. 1 and generally to FIGS. 3-8 and 12-17, in one or more examples, the method 2000 includes a step of (block 2026) moving the second arm 130 relative to the base 122 and to the forming-surface 104 such that the third ply-portion 208 is placed on the third surface-portion 116 of the forming-surface 104 (block 2028). In one or more examples, the first surface-portion 108 and the third surface-portion 116 are non-coplanar.

Referring particularly to FIG. 1 and generally to FIGS. 3-17, in one or more examples, the method 2000 includes a step of (block 2016) holding the first ply-portion 204 on the first surface-portion 108. As an example, the end effector 102 is moved relative to the forming-surface 104 (block 2012) such that the first ply-portion 204 of the ply 202 is held on the first surface-portion 108 of the forming-surface 104 (block 2016) using the base 122 and the base-gripper 126. The method 2000 includes a step of (block 2030) draping the third ply-portion 208 over the second radiused corner 118 of the forming-surface 104 between the first surface-portion 108 and the third surface-portion 116 of the forming-surface 104. As an example, the second arm 130 is moved relative to the base 122 and to the forming-surface 104 (block 2026) such that the third ply-portion 208 is draped over the second radiused corner 118 of the forming-surface 104 between the first surface-portion 108 and the third surface-portion 116 of the forming-surface 104 (block 2030).

Referring particularly to FIG. 1 and generally to FIGS. 3-17, in one or more examples, the method 2000 includes a step of (block 2032) applying tension 114 to the third ply-portion 208. As an example, the second arm 130 is moved relative to the base 122 (block 2026) such that tension 114 is applied to the third ply-portion 208 of the ply 202 (block 2032).

Referring to FIGS. 1 and 2, in one or more examples, the method 1000, such as the moving step (e.g., block 1004) and/or the placing steps (e.g., blocks 1008, 1016 and 1022) of the method 1000, and the method 2000, such as the moving step (e.g., block 2012) and/or the placing steps (e.g., blocks 2014, 2020 and 2028) of the method 2000, include a step of selectively orienting the ply 202 relative to another one of the plies 220. In one or more examples, the ceramic reinforcement 210 of each one of the plies 220 has a fiber orientation (e.g., fabric weave) of the reinforcement material. The orientation of the fibers of the ceramic reinforcement 210 can be unidirectional, random, bidirectional, and multi-directional. In one or more examples, the moving and/or placing steps include a step of selectively orienting the fibers (e.g., selecting the fiber orientation) of the ceramic reinforcement 210 of the ply 202 relative to the fiber orientation of the prior-ply 222 or another previously placed one of the plies 220.

Referring now to FIGS. 2-8, the following are examples of a system 100 for manufacturing the ceramic matrix composite structure 218, according to the present disclosure. In one or more examples, the system 100 utilizes the end effector 102 for positioning (e.g., picking-and-placing) the ply 202 of the ceramic matrix composite material 200. The system 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIG. 3-18, in one or more examples, the system 100 includes a robotic manipulator 142. The system 100 includes the end effector 102. The end effector 102 is coupled to the robotic manipulator 142. The end effector 102 includes the base 122. The end effector 102 includes the arm 124 that is coupled to and movable relative to the base 122. The end effector 102 includes the base-gripper 126 that is coupled to the base 122. The end effector 102 includes the arm-gripper 128 that is coupled to the arm 124. The base-gripper 126 and the arm-gripper 128 hold the ply 202 of the ceramic matrix composite material 200. The robotic manipulator 142 moves the ply 202 relative to the forming-surface 104 such that the first ply-portion 204 is placed on the first surface-portion 108 of the forming-surface 104. The arm 124 moves relative to the base 122 and relative to the forming-surface 104 such that the second ply-portion 206 of the ply 202 is placed on the second surface-portion 110 of the forming-surface 104.

Referring to FIG. 3, in one or more examples, the robotic manipulator 142 is any suitable programmable platform that is configured to move and position the end effector 102 in three-dimensional space, for example, under direction from the computer 168. The robotic manipulator 142 includes various operation components, such as motors, actuators, articulating joints, encoders, and the like. Examples of the robotic manipulator 142 include a robotic arm, an overhead gantry, and the like, such as linkages, cams, levers, and various other mechanically induced motion devices.

Referring to FIGS. 3-17, in one or more examples, the base 122 of the end effector 102 holds the first ply-portion 204 of the ply 204 on the first surface-portion 108 of the forming-surface 104. The arm 124 moves relative to the base 122 and relative to the forming-surface 104 such that the second ply-portion 206 of the ply 204 is draped over the radiused corner 112 of the forming-surface 104 between the first surface-portion 108 and the second surface-portion 110 of the forming-surface 104.

Referring to FIGS. 3-17, in one or more examples, the arm 124 is linearly movable relative to the base 122. In one or more examples, the arm 124 moves relative to the base 122 such that tension 114 is applied to the second ply-portion 206 of the ply 202. In one or more examples, the arm 124 moves linearly (e.g., inward and outward) relative to the base 122, for example, in the directions of directional arrow 184. Linear movement of the arm 124 relative to the base 122, while the ply 202 is gripped by the base-gripper 126 and the arm-gripper 128, applies tension 114 to the second ply-portion 206. The end effector 102 includes any suitable combination of operational components that is configured to drive and control linear movement of the arm 124 relative to the base 122, such as motors, actuators, transmissions, gears, and the like.

Referring to FIGS. 3-18, in one or more examples, the arm 124 is rotationally movable relative to the base 122. In one or more examples, the arm 124 moves rotationally relative to the base 122, for example, in the directions of directional arrow 188. Rotational movement of the arm 124 relative to the base 122, while the ply 202 is gripped by the base-gripper 126 and the arm-gripper 128, places the second ply-portion 206 on the second surface-portion 110 of the forming-surface 104 while draping the second ply-portion 206 over the radiused corner 112. The end effector 102 includes any suitable combination of operational components that is configured to drive and control rotary movement of the arm 124 relative to the base 122, such as motors, actuators, transmissions, gears, and the like.

In one or more examples, the arm 124 moves linearly relative to the base 122, for example, in the directions of directional arrow 184, while the arm 124 moves rotationally relative to the base 122, for example, in the directions of directional arrow 188. Linear movement and rotational movement of the arm 124 relative to the base 122, while the ply 202 is gripped by the base-gripper 126 and the arm-gripper 128, applies tension 114 to the second ply-portion 206 while the second ply-portion 206 is draped over the radiused corner 112 and placed on the second surface-portion 110.

Referring to FIGS. 3-18, in one or more examples, the end effector 102 includes the second arm 130 that is coupled to and movable relative to the base 122. The end effector 102 includes the second arm-gripper 132 that is coupled to the second arm 130. The second arm-gripper 132 holds the ply 202. The second arm 130 moves relative to the base 122 and relative to the forming-surface 104 such that the third ply-portion 208 of the ply 202 is placed on the third surface-portion 116 of the forming-surface 104.

Referring to FIGS. 3-8 and 12-17, in one or more examples, the second arm 130 moves relative to the base 122 and relative to the forming-surface 104 such that the third ply-portion 208 of the ply 204 is draped over the second radiused corner 118 of the forming-surface 104 between the first surface-portion 108 and the third surface-portion 116 of the forming-surface 104.

Referring to FIGS. 3-8 and 12-17, in one or more examples, the arm 124 and the second arm 130 are linearly movable relative to the base 122. In one or more examples, the arm 124 and the second arm 130 move relative to the base 122 such that tension 114 is applied to the second ply-portion 206 and the third ply-portion 208 of the ply 204. In one or more examples, the arm 124 moves relative to the base 122 such that tension 114 is applied to the second ply-portion 206 of the ply 202 and the second arm 130 moves relative to the base 122 such that tension 114 is applied to the third ply-portion 208 of the ply 202. In one or more examples, the arm 124 moves linearly (e.g., inward and outward) relative to the base 122, for example, in the directions of directional arrow 184. In one or more examples, the second arm 130 moves linearly (e.g., inward and outward) relative to the base 122, for example, in the directions of directional arrow 186. Linear movement of the arm 124 and the second arm 130 relative to the base 122, while the ply 202 is gripped by the base-gripper 126, the arm-gripper 128, and the second arm-gripper 132, applies tension 114 to the second ply-portion 206 and the third ply-portion 208. The end effector 102 includes any suitable combination of operational components that is configured to drive and control linear movement of the arm 124 and the second arm 130 relative to the base 122, such as motors, actuators, transmissions, gears, and the like.

Referring to FIG. 3, in one or more examples, the system 100 includes a sensor 144. The sensor 144 detects (e.g., is configured to detect) tension 114 applied to the ply 202, such as tension 114 applied to at least one of the second ply-portion 206 and/or the third ply-portion 208 of the ply 204. In one or more examples, data or measurements from the sensor 144 are transmitted to a feedback controller (e.g., of the computer 168) and are used to direct movement of the arm 124 and/or the second arm 130.

Referring to FIGS. 3-18, in one or more examples, the arm 124 and the second arm 130 are rotationally movable relative to the base 122. In one or more examples, the arm 124 moves rotationally relative to the base 122, for example, in the directions of directional arrow 188. In one or more examples, the second arm 130 moves rotationally relative to the base 122, for example, in the directions of directional arrow 190. Rotational movement of the arm 124 and the second arm 130 relative to the base 122, while the ply 202 is gripped by the base-gripper 126 and the arm-gripper 128, places the second ply-portion 206 on the second surface-portion 110 of the forming-surface 104 while draping the second ply-portion 206 over the radiused corner 112 and places the third ply-portion 208 on the third surface-portion 116 of the forming-surface 104 while draping the third ply-portion 208 over the second radiused corner 118. The end effector 102 includes any suitable combination of operational components that is configured to drive and control rotary movement of the arm 124 and the second arm 130 relative to the base 122, such as motors, actuators, transmissions, gears, and the like.

In one or more examples, the arm 124 moves linearly relative to the base 122, for example, in the directions of directional arrow 184, while the arm 124 moves rotationally relative to the base 122, for example, in the directions of directional arrow 188. In one or more examples, the second arm 130 moves linearly relative to the base 122, for example, in the directions of directional arrow 186, while the second arm 130 moves rotationally relative to the base 122, for example, in the directions of directional arrow 190. Linear movement and rotational movement of the arm 124 and the second arm 130 relative to the base 122, while the ply 202 is gripped by the base-gripper 126, the arm-gripper 128, and the second arm-gripper 132, applies tension 114 to the second ply-portion 206 while the second ply-portion 206 is draped over the radiused corner 112 and placed on the second surface-portion 110 and applies tension 114 to the third ply-portion 208 while the third ply-portion 208 is draped over the second radiused corner 118 and placed on the third surface-portion 116.

Referring to FIGS. 3-18, in one or more examples, the base-gripper 126 is movable relative to the base 122. In one or more examples, the base-gripper 126 is linearly movable relative to the base 122. Linear movement of the base-gripper 126 relative to the base 122 enables the base-gripper 126 to be selectively and controllably positioned relative to the ply 202 and the forming-surface 104 during pick-up and placement of the ply 202. The end effector 102 includes any suitable combination of operational components that is configured to drive and control rotary movement of the base-gripper 126 relative to the base 122, such as motors, actuators, transmissions, gears, and the like.

Referring to FIGS. 3-18, in one or more examples, the arm-gripper 128 is movable relative to the arm 124. In one or more examples, the arm-gripper 128 is linearly movable relative to the arm 124. Linear movement of the arm-gripper 128 relative to the arm 124 enables the arm-gripper 128 to be selectively and controllably positioned relative to the ply 202 and the forming-surface 104 during pick-up and placement of the ply 202. Linear movement of the arm-gripper 128 relative to the arm 124 can also be used for applying tension 114 to the second ply-portion 206 of the ply 202. The end effector 102 includes any suitable combination of operational components that is configured to drive and control rotary movement of the arm-gripper 128 relative to the arm 124, such as motors, actuators, transmissions, gears, and the like.

Referring to FIGS. 3-18, in one or more examples, the second arm-gripper 132 is movable relative to the second arm 130. In one or more examples, the second arm-gripper 132 is linearly movable relative to the second arm 130. Linear movement of the second arm-gripper 132 relative to the second arm 130 enables the second arm-gripper 132 to be selectively and controllably positioned relative to the ply 202 and the forming-surface 104 during pick-up and placement of the ply 202. Linear movement of the second arm-gripper 132 relative to the second arm 130 can also be used for applying tension 114 to the third ply-portion 208 of the ply 202. The end effector 102 includes any suitable combination of operational components that is configured to drive and control rotary movement of the second arm-gripper 132 relative to the second arm 130, such as motors, actuators, transmissions, gears, and the like.

Referring to FIG. 3, in one or more examples, at least one of the base-gripper 126, the arm-gripper 128, and the second arm-gripper 132 includes a vacuum gripper.

Referring to FIGS. 3, in one or more examples, at least one of the base-gripper 126, the arm-gripper 128, and the second arm-gripper 132 includes an electrostatic gripper.

Referring to FIGS. 3-18, in one or more examples, the system 100 includes the tool 134. The tool 134 includes the tool-surface 136. Movement of the arm 124 relative to the base 122 conforms the ply 202 to the tool-surface 136.

Referring to FIGS. 3-14, in one or more examples, the forming-surface 104 is formed by the tool-surface 136. The first surface-portion 108 and the second surface-portion 110 are non-coplanar.

Referring to FIGS. 3 and 15-17, in one or more examples, the forming-surface 104 is formed by the prior-ply-surface 224 of the prior-ply 222 of the ceramic matrix composite material 200, which is positioned on the tool 134. The first surface-portion 108 and the second surface-portion 110 are non-coplanar.

Referring to FIGS. 3, 6 and 8, in one or more examples, the system 100 includes a tacking head 146. In one or more examples, the end effector 102 includes the tacking head 146. As an example, the tacking head 146 is integrated to the end effector 102. In one or more examples, the tacking head 146 is coupled to the base 122. In one or more examples, the tacking head 146 is movable relative to the base 122. Selective actuation of the tacking head 146 moves the tacking head 146 relative to the base 122 and relative to the forming-surface 104 to compact an area of the first ply-portion 204 on the first surface-portion 108 of the forming-surface 104.

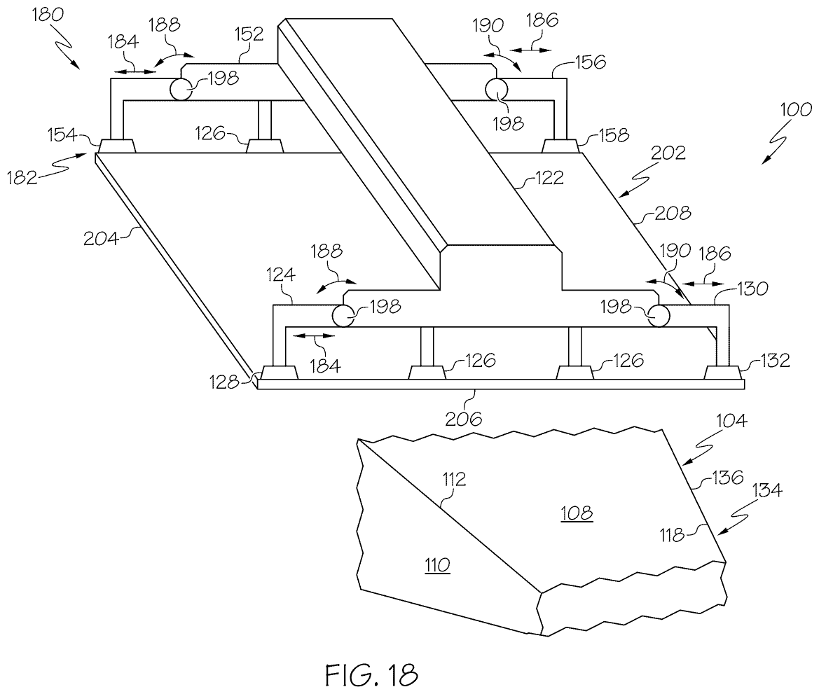

Referring to FIG. 18, in one or more examples, the end effector 102 includes any suitable number of positioning arms 180 that are coupled to and/or that are movable relative to the base 122. In one or more examples, the second arm 130 is positioned opposite the arm 124 relative to the base 122. In one or more examples, the end effector 102 includes a third arm 152 that is coupled to the base 122 and that is spaced away from the arm 124 on the same side of the base 122 as the arm 124. In one or more examples, the end effector 102 includes a fourth arm 156 that is coupled to the base 122, that is spaced away from the base 122 on the same side of the base 122 as the second arm 130, and that is opposite the third arm 152. In these examples, the arm 124 (e.g., first arm), the second arm 130, the third arm 152, the fourth arm 156, and any additional number of arms are examples of the positioning arms 180.

Referring to FIG. 18, in one or more examples, the end effector 102 includes any suitable number of grippers 182. In one or more examples, the arm 124 includes any number of arm-grippers 128. In one or more examples, the second arm 130 includes any number of second arm-grippers 132. In one or more examples, the third arm 152 includes any number of third arm-grippers 154. In one or more examples, the fourth arm 156 includes any number of fourth arm-grippers 158. In one or more examples, the base 122 includes any number of base-grippers 126. In these examples, the base-grippers 126, the arm-grippers 128 (e.g., first arm-grippers), the second arm-grippers 132, the third arm-grippers 154, the fourth arm-grippers 158, and any additional number of grippers are examples of the grippers 182.

Referring to FIG. 18, in one or more examples, the end effector 102 includes a number of joints 198. Each one of the joints 198 enables rotational movement of a corresponding one of the positioning arms 180 relative to the base 122.

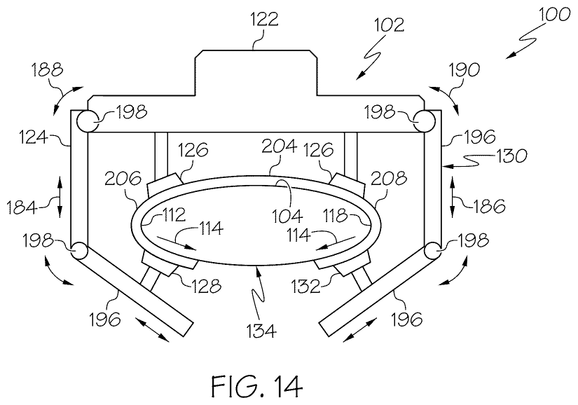

Referring to FIG. 14, in one or more examples, one or more of the positioning arms 180 can include a number of arm-portions 196. One of the arm-portions 196 of a respective one of the positioning arms 180 can be movable (e.g., linearly and/or rotationally) relative to another one of the arm-portions 196, such as about one of the joints 198 of the respective one of the positioning arms 180. Linear and/or rotational movement of the arm-portions 196 relative to each other enable the positioning arms 180 to properly position the ply 202 on the forming-surface 104.

Referring to FIG. 3, in one or more examples, the computer 168 includes a data-processing system 170 configured to received, analyze, generate, and/or transmit various types of data, information, and/or signals, for example, to control or otherwise provide instructions operational components of the system 100 and/or perform the steps of the method 1000. In one or more examples, the data-processing system 170 includes a processor 172 and memory 174 storing instructions (e.g., program code 176) that, when executed, cause the processor 172 to initiate performance of one or more operational steps of the method 1000 or instructs the system 100 to perform one or more operational steps of the method 1000. In one or more examples, the processor 172 is configured to read from and write to the memory 174. In one or more examples, the processor 172 is configured to receive input commands and provide output commands. In one or more examples, the processor 172 is a multi-functional processor such as, for example, a central processing unit. In one or more examples, the functions of the processor 172 are performed by a local processor, a remote processor, or a combination thereof. In one or more examples, the processor 172 is implemented in hardware alone (e.g., a circuit, a microprocessor etc.) have certain aspects in software including firmware alone or can be a combination of hardware and software (including firmware). In one or more examples, the processor 172 can be implemented using instructions that enable hardware functionality, for example, by using executable computer program instructions (e.g., program code 176) in a general-purpose or special-purpose processing unit that is stored on the memory 174 or other computer readable storage medium (e.g., disk, memory, etc.) to be executed by the processor 172. The memory 174 stores a computer program (e.g., program code 176) that includes computer program instructions that control the operation of the processor 172 when loaded into processing circuitry. The computer program instructions provide the logic and routines that enable the processor 172 to perform the method 1000 illustrated in FIG. 2. The processing circuitry, by reading the memory 174, is able to load and execute the program code 176. The program code 176 may arrive at the processor 172 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program. The delivery mechanism may be a signal configured to reliably transfer the computer program. The apparatus may propagate or transmit the computer program as a computer data signal. Although the memory 174 is illustrated as a single component it may be implemented as one or more separate components some or all of which may be integrated/removable and/or may provide permanent/semi-permanent/dynamic/cached storage. References to “computer-readable storage medium,” “computer program product,” “tangibly embodied computer program,” etc. or a “controller,” “computer,” “processor,” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

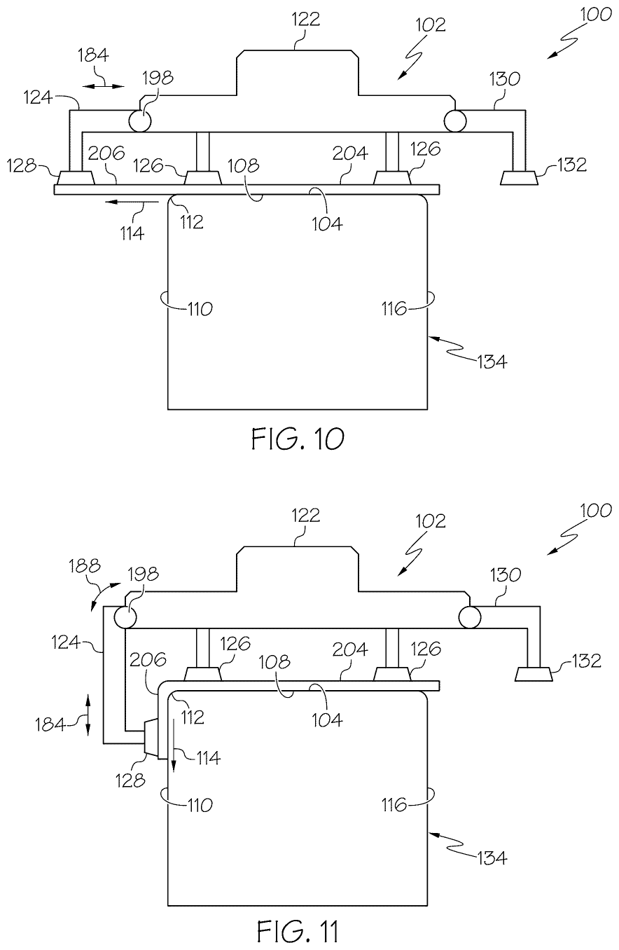

Referring now to FIGS. 10 and 11, examples of the method 1000 and the system 100 described herein, may be related to, or used in the context of, the aerospace manufacturing and service method 1100, as shown in the flow diagram of FIG. 10 and an aircraft 1200, as schematically illustrated in FIG. 11. As an example, the aircraft 1200 and/or the manufacturing and service method 1100 may include or utilize components that are manufactured of ceramic matrix composite materials, which are compacted using the system 100 and/or according to the method 1000.

Referring to FIG. 11, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aircraft 1200 can have any number of components made of ceramic matrix composite materials, which are compacted using the system 100 and/or according to the method 1000.

Referring to FIG. 10, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 10 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the method 1000 and the system 100, shown and described herein, may be employed during any one or more of the stages of the manufacturing and service method 1100 shown in the flow diagram illustrated by FIG. 10. In an example, components of the aircraft 1200 can be manufactured of ceramic matrix composite materials compacted using the system 100 and/or according to the method 1000 during a portion of component and subassembly manufacturing (block 1106) and/or system integration (block 1108). Further, components of the aircraft 1200 can be manufactured of ceramic matrix composite materials compacted using the system 100 and/or according to the method 1000 while the aircraft 1200 is in service (block 1112). Also, components of the aircraft 1200 can be manufactured of ceramic matrix composite materials compacted using the system 100 and/or according to the method 1000 during system integration (block 1108) and certification and delivery (block 1110). Similarly, components of the aircraft 1200 can be manufactured of ceramic matrix composite materials compacted using the system 100 and/or according to the method 1000 while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 3-18 and 20, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 3-18 and 20, referred to above, need be included in every example and not all elements, features, and/or components described herein are necessarily depicted in each illustrative example. Accordingly, some of the elements, features, and/or components described and illustrated in FIGS. 3-18 and 20 may be combined in various ways without the need to include other features described and illustrated in FIGS. 3-18 and 20, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 3-18 and 20, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 3-18 and 20, and such elements, features, and/or components may not be discussed in detail herein with reference to each of FIGS. 3-18 and 20. Similarly, all elements, features, and/or components may not be labeled in each of FIGS. 3-18 and 20, but reference numerals associated therewith may be utilized herein for consistency.

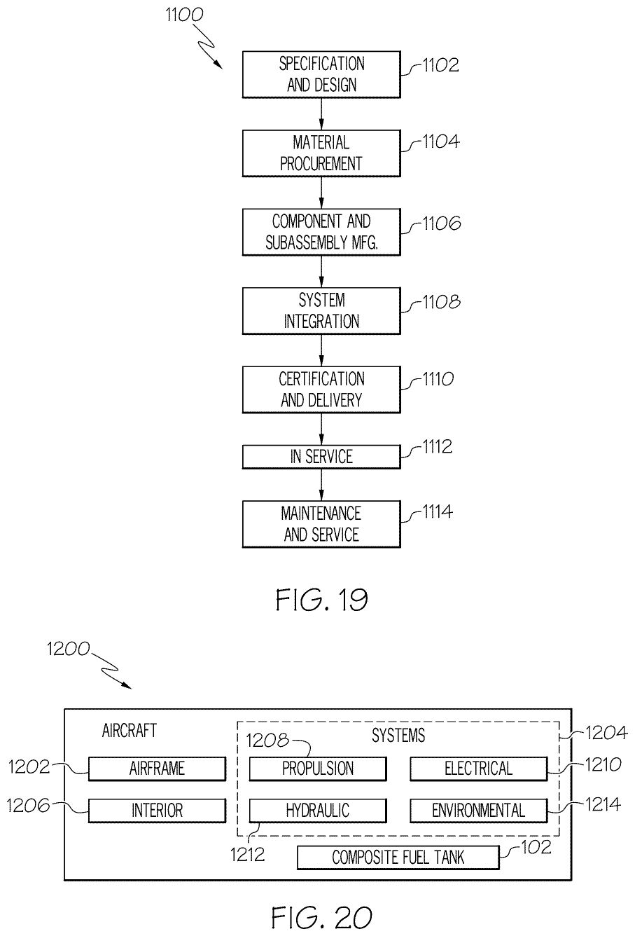

In FIGS. 1, 2 and 19, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 1, 2 and 19 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100, the method 1000, and the method 2000 have been shown and described, modifications may occur to those skilled in the art upon reading the specification. The present application includes such modifications and is limited only by the scope of the claims.

What is claimed is:

1. A method for manufacturing a ceramic matrix composite structure, the method comprising:
picking up a ply of a ceramic matrix composite material using an end effector;
moving the ply to a forming-surface using the end effector; and
conforming the ply to a shape of the forming-surface using the end effector; and
applying tension to at least one portion of the ply using the end effector while conforming the ply.

2. The method of claim 1, wherein:
conforming the ply comprises:
placing a first ply-portion of the ply on a first surface-portion of the forming-surface using the end effector; and
placing a second ply-portion of the ply on a second surface-portion of the forming-surface using the end effector; and
the first surface-portion and the second surface-portion are non-coplanar.

3. The method of claim 2, wherein conforming the ply further comprises:
holding the first ply-portion of the ply on the first surface-portion of the forming-surface using the end effector; and
draping the second ply-portion of the ply over a radiused corner of the forming-surface between the first surface-portion and the second surface-portion of the forming-surface using the end effector before placing the second ply-portion of the ply on the second surface-portion.

4. The method of claim 3, wherein conforming the ply further comprises applying the tension to the second ply-portion of the ply using the end effector while draping the second ply-portion over the radiused corner of the forming-surface and placing the second ply-portion on the second surface-portion of the forming-surface.

5. The method of claim 3, wherein:
conforming the ply further comprises:
draping a third ply-portion of the ply over a second radiused corner of the forming-surface between the first surface-portion and a third surface-portion of the forming-surface using the end effector before placing the third ply-portion of the ply on the third surface-portion; and
placing the third ply-portion of the ply on the third surface-portion of the forming-surface using the end effector; and
the first surface-portion and the third surface-portion are non-coplanar.

6. The method of claim 5, wherein conforming the ply further comprises applying the tension to the third ply-portion of the ply using the end effector while draping the third ply-portion over the second radiused corner of the forming-surface and placing the third ply-portion on the third surface-portion of the forming-surface.

7. The method of claim 2, further comprising selecting a fiber orientation of a ceramic reinforcement of the ply relative to a prior-ply.

8. The method of claim 1, wherein:
the end effector comprises:
a base;
an arm that is coupled to and movable relative to the base;
a base-gripper that is coupled to the base; and
an arm-gripper that is coupled to the arm;
picking up the ply comprises:
adhering the base-gripper to a first ply-portion of the ply; and
adhering the arm-gripper to a second ply-portion of the ply;
conforming the ply comprises:
moving the end effector relative to the forming-surface such that the first ply-portion of the ply is placed on a first surface-portion of the forming-surface; and
moving the arm relative to the base and to the forming-surface such that the second ply-portion is placed on a second surface-portion of the forming-surface; and
the first surface-portion and the second surface-portion are non-coplanar.

9. The method of claim 8, wherein conforming the ply further comprises:
holding the first ply-portion on the first surface-portion; and
moving the arm relative to the base and to the forming-surface such that the second ply-portion is draped over a radiused corner of the forming-surface between the first surface-portion and the second surface-portion of the forming-surface.

10. The method of claim 9, wherein:
the end effector further comprises:
a second arm that is coupled to and movable relative to the base; and
a second arm-gripper is coupled to the second arm;
picking up the ply further comprises adhering the second arm-gripper to a third ply-portion of the ply;
conforming the ply further comprises moving the second arm relative to the base and to the forming-surface such that the third ply-portion is placed on a third surface-portion of the forming-surface; and
the first surface-portion and the third surface-portion are non-coplanar.

11. The method of claim 10, wherein conforming the ply further comprises:
holding the first ply-portion on the first surface-portion; and
moving the second arm relative to the base and to the forming-surface such that the third ply-portion is draped over a second radiused corner of the forming-surface between the first surface-portion and the third surface-portion of the forming-surface.

12. The method of claim 11, wherein conforming the ply further comprises:
moving the arm relative to the base such that the tension is applied to the second ply-portion of the ply; and
moving the second arm relative to the base such that the tension is applied to the third ply-portion of the ply.

13. The method of claim 1, wherein:
the ply of the ceramic matrix composite material comprises a ceramic reinforcement and a ceramic matrix;
the ceramic reinforcement comprises at least one of carbon reinforcement fibers, silicon carbide reinforcement fibers, alumina reinforcement fibers, alumina silica reinforcement fibers, aluminum nitride reinforcing fibers, silicon nitride reinforcement fibers, mullite reinforcement fibers, silica/quartz reinforcement fibers, basalt reinforcement fibers, and zirconia reinforcement fibers; and
the ceramic matrix comprises at least one of a carbon matrix, a silicon carbide matrix, an alumina matrix, an alumina silica matrix, an aluminum nitride matrix, a silicon nitride matrix, a mullite matrix, a geo-polymer matrix, and a zirconia matrix.

14. A method for positioning a ceramic matrix composite material, the method comprising steps of:
positioning an end effector relative to a ply of the ceramic matrix composite material, wherein the end effector comprises:
a base;
an arm that is coupled to and movable relative to the base;
a base-gripper that is coupled to the base; and
an arm-gripper that is coupled to the arm;
adhering the base-gripper to a first ply-portion of the ply;
adhering the arm-gripper to a second ply-portion of the ply;
moving the end effector relative to a forming-surface such that the first ply-portion of the ply is placed on a first surface-portion of the forming-surface; and
moving the arm relative to the base and to the forming-surface such that the second ply-portion is placed on a second surface-portion of the forming-surface, wherein the first surface-portion and the second surface-portion are non-coplanar.

15. The method of claim 14, further comprising:
holding the first ply-portion on the first surface-portion;
moving the arm relative to the base such that a tension is applied to the second ply-portion of the ply; and
moving the arm relative to the base and to the forming-surface such that the second ply-portion is draped over a radiused corner of the forming-surface between the first surface-portion and the second surface-portion of the forming-surface.

16. A system for manufacturing a ceramic matrix composite structure, the system comprising:
a robotic manipulator; and
an end effector that is coupled to the robotic manipulator, wherein:
the end effector comprises:
a base;
an arm that is coupled to and movable relative to the base;
a base-gripper that is coupled to the base; and
an arm-gripper that is coupled to the arm;
the base-gripper and the arm-gripper hold a ply of ceramic matrix composite material;
the robotic manipulator moves the ply relative to a forming-surface such that a first ply-portion is placed on a first surface-portion of the forming-surface; and
the arm moves relative to the base and the forming-surface such that a second ply-portion of the ply is placed on a second surface-portion of the forming-surface.

17. The system of claim 16, wherein:
the base of the end effector holds the first ply-portion of the ply on the first surface-portion of the forming-surface; and
the arm moves relative to the base and the forming-surface such that the second ply-portion of the ply is draped over a radiused corner of the forming-surface between the first surface-portion and the second surface-portion of the forming-surface.

18. The system of claim 17, wherein the arm moves relative to the base such that a tension is applied to the second ply-portion of the ply.

19. The system of claim 17, wherein:
the end effector further comprises:
a second arm that is coupled to and movable relative to the base; and
a second arm-gripper that is coupled to the second arm;
the second arm-gripper holds the ply; and
the second arm moves relative to the base and the forming-surface such that a third ply-portion of the ply is placed on a third surface-portion of the forming-surface.

20. The system of claim 19, wherein the second arm moves relative to the base and the forming-surface such that the third ply-portion of the ply is draped over a second radiused corner of the forming-surface between the first surface-portion and the third surface-portion of the forming-surface.
